(19) United States
(12) Patent Application Publication
(10) Pub. No.: US 2003/0039719 A1
(43) Pub. Date: Feb. 27, 2003

(54) Closing unit for an injection molding machine or press

(75) Inventor: Manfred Armbruster, Schwaig (DE)

Correspondence Address: HENRY M FEIEREISEN, 350 FIFTH AVENUE, SUITE 3220, NEW YORK, NY, 10118, US

(73) Assignee: DEMAG ERGOTECH GMBH, Schwaig (DE)

(21) Appl. No.: 10/223,269

(22) Filed: Aug. 19, 2002

(30) Foreign Application Priority Data
Aug. 23, 2001 (DE) 101 41 277.0

(51) Int. Cl. B29C 45/66

(52) U.S. Cl. 425/593; 425/451.6

(57) ABSTRACT

A mold closing unit for an injection molding machine or press; includes a drive mechanism, and a toggle mechanism having a first pair of linkages which are connected to one another at a first knuckle point. One linkage is connected to a stationary component at a second knuckle point and the other linkage is connected to a movable mold mounting plate at a third knuckle point. At least one of the linkages is operatively connected to the drive mechanism at a fourth knuckle point, wherein the fourth knuckle point is spaced from the first knuckle point by a first distance, and spaced from the second knuckle point by a second distance, wherein a sum of the first and second distances is greater than 1.2 times a distance between the first and second knuckle points.

### CROSS-REFERENCES TO RELATED APPLICATIONS

This application claims the priority of German Patent Application Serial No. 101 41 277.0, filed Aug. 23, 2001, pursuant to 35 U.S.C. 119(a)-(d), the subject matter of which is incorporated herein by reference.

### BACKGROUND OF THE INVENTION

The present invention relates, in general, to a closing unit for an injection molding machine or press.

U.S. Pat. Nos. 5,297,952 and 5,511,963 describe each a closing unit for injection molding machines, including a generally Y-shaped toggle mechanism having two levers and arranged between an end plate and a moveable mold mounting plate for moving the moveable mold mounting plate. Acting on a middle joint of the toggle mechanism is a piston rod of a hydraulic piston and cylinder unit. Two arms connect the cylinder of the piston and cylinder unit with outer joints of the toggle mechanism. The piston and cylinder unit is arranged transversely to the travel direction of the moveable mold mounting plate, and operates between the middle joint of the toggle mechanism and the arms disposed at the outer joints. When the piston moves into the cylinder, both levers of the toggle mechanism form a steep “V”, and together with the piston the configuration of a “Y”. Both outer joints of the toggle mechanism approach closely one another so that the closing unit of the injection molding machine is open. When the piston moves out of the cylinder, the middle joint of the toggle mechanism is removed from the points of articulation of the arms to the cylinder. The “V”-shaped configuration of the levers of the toggle mechanism becomes increasingly flatter until both levers coincide in a line. The moveable mold mounting plate is thus shifted in closing direction.

The arrangement of the piston and cylinder unit requires much installation space in a direction transversely to the longitudinal axis of the closing unit. As the closing unit opens, the cylinder covers a long distance in downward direction perpendicular to the longitudinal axis of the injection molding machine. Another shortcomings relates to the force distribution. During closing operation, the piston pushes the middle joint of the toggle mechanism upwards and thus moves the levers upwards while pushing them to the outside at the same time. Counteracting the force of the piston is a force component, perpendicular to the closing direction, in the arms as resultant, i.e. the arms are subject to tensile forces. The closing force of the closing unit is based on the superimposition of the horizontal force component of the pressure force of the lever and the push force of the arms. As they act in opposition to one another, the levers and arms must be dimensioned strong enough.

The Handbook “Kunststoff Maschinen Führer” [Plastics Machines Guide], 3^{rd} ed., published by Dr.-Ing. Friedrich Jahannaber, Carl Hansen Verlag München Wien 1992, ISBN 3446-16292-5, describes on page 95, FIG. 43, a single-hinged toggle-type closing unit with five pivot points. This unit has shortcomings because of the great installation space required in axial direction for the coaxially arranged hydraulic cylinder.

It would therefore be desirable and advantageous to provide an improved closing unit for an injection molding machine or press, which obviates prior art shortcomings and which is compact in structure so as to require little installation pace in vertical and axial directions, while realizing a beneficial force introduction.

### SUMMARY OF THE INVENTION

According to one aspect of the present invention, a mold closing unit for an injection molding machine or press; includes a drive mechanism; and a toggle mechanism having a first pair of linkages connected to one another at a first knuckle point, one linkage connected to a stationary component at a second knuckle point and the other linkage connected to a movable mold mounting plate at a third knuckle point, at least one of the linkages operatively connected to the drive mechanism at a fourth knuckle point, wherein the fourth knuckle point is spaced from the first knuckle point by a first distance, and spaced from the second knuckle point by a second distance, wherein a sum of the first and second distances is greater than 1.2 times a distance between the first and second knuckle points.

The present invention resolves prior art problems by providing an additional (fourth) knuckle point of at least one of the linkages of the toggle mechanism to form with the other knuckle points of the toggle mechanism of this one linkage a triangle whereby the triangular configuration is maintained during operation of the toggle mechanism. The articulation of the drive mechanism at this additional knuckle point has the advantage of a beneficial force introduction. Of course, each of both linkages of the toggle mechanism may be of triangular configuration with an additional knuckle point, with the drive mechanism articulated between both these knuckle points. In either one of these embodiments, the drive mechanism can be arranged in longitudinal direction of the injection molding machine or press. This disposition saves vertical installation space as well as horizontal installation space because the accommodation of the drive mechanism exploits the axial extension of the toggle mechanism.

According to another feature of the present invention, a second pair of linkages may be connected to the drive mechanism at a fifth knuckle point. In this way, the drive mechanism can be arranged in substantial horizontal disposition, e.g., in a direction along the closing direction. The drive mechanism operates between the additional knuckle point on one of both linkages of the toggle mechanism and a knuckle point which interconnects the second pair of linkages. The second pair of linkages is articulated to the same knuckle points as the linkages of the toggle mechanism. When the drive mechanism, for example a spindle drive with quill motor or a linear drive or a double-acting hydraulic cylinder, is extended, the pair of linkages of the toggle mechanism stretches. The second linkage pair is opened from a narrow “V” to a wide “V”: Advantageously, the horizontal forces components from the linkages of the toggle mechanism and the further linkages of the second pair of linkages act in a same direction during closing operation of the closing unit. In addition, the drive mechanism is shifted during opening and closing of the closing unit only slightly, predominantly in parallel relationship to the longitudinal axis of the closing unit. Moreover, the pairs of linkages utilize during opening of the closing unit the existing space in both directions perpendicular to the longitudinal axis of the closing unit. The needed installation space is therefore comparably small.

The toggle mechanism may operate in pushing mode in a three-platen injection molding machine between an end plate and a moveable mold mounting plate, as well as in pulling mode in a two-platen injection molding machine between the fixed mold mounting plate and the moveable mold mounting plate. The three-platen configuration affords a beneficial central force introduction into the moveable mold mounting plate via a central toggle mechanism, whereas the two-platen configuration results in a shorter axial installation length.

According to another feature of the present invention, the drive mechanism may be connected at a point of articulation to a machine bed of the injection molding machine or press or a structural part connected therewith, i.e. directly or indirectly. Although this configuration requires the machine bed to absorb the forces generated by the drive mechanism, the particular provision of a stationary toggle mechanism in a two-platen design results in a smaller number of components.

According to another feature of the present invention, there may be provided a second toggle mechanism, wherein the two toggle mechanisms are arranged in symmetric relationship to a longitudinal center axis of the injection molding machine or press. In this way, it is possible to integrate a plasticizing unit between the toggle mechanisms so that a parallel disposition between the toggle mechanisms and the plasticizing unit is able to save axial installation space. Suitably, the two toggle mechanisms are movable by the drive mechanism via a crosshead.

When the injection molding machine has to operate under clean air conditions in the working space, e.g. when used in the medical field, the drive mechanism is suitably a spindle drive with a quill motor, or a linear drive. Contaminations, e.g., through abraded particles of seals of a hydraulic system, can hereby be avoided. When clean air conditions are of no concern, the drive mechanism may be designed as a double-acting hydraulic cylinder.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic side view of a first embodiment of a closing unit according to the present invention, for use in an injection molding machine and shown in closed disposition;

FIG. 2 is a schematic side view of the closing unit in open disposition;

FIG. 3 is a schematic side view of a second embodiment of a closing unit according to the present invention, for use in an injection molding machine; and

FIG. 4 is a top view of the closing unit of FIG. 3.

### DETAILED DESCRIPTION OF PREFERRED EMBODIMENTS

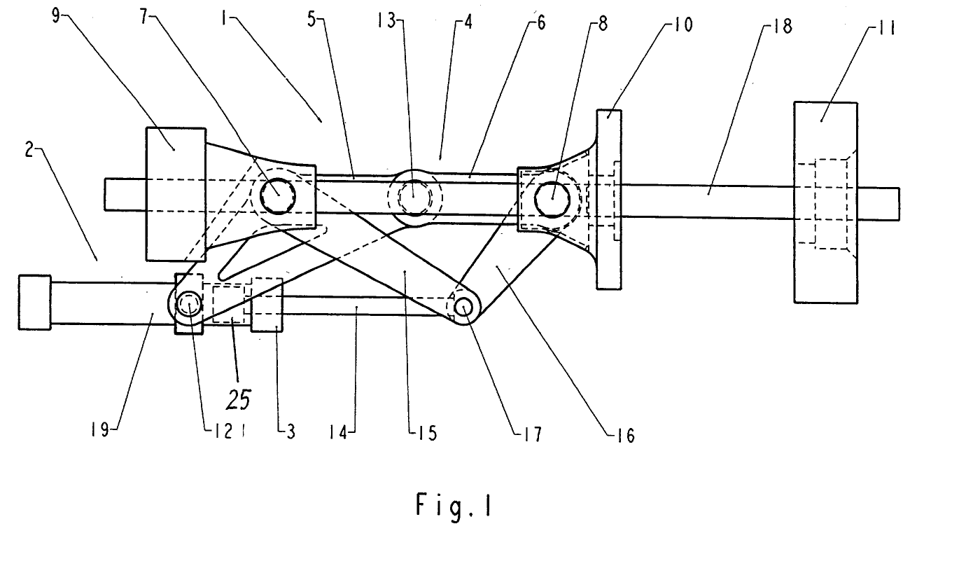

Turning now to the drawing, and in particular to FIG. 1, there is shown a schematic side view of a first embodiment of a closing unit according to the present invention, generally designated by reference numeral 1, for use in an injection molding machine of the tree-platen type which includes a fixed end plate 9, a moveable mold mounting plate 10 and a fixed mold mounting plate 11. A tie bar 18 extends between the end plate 9 and the fixed mold mounting plate 11 and is secured axially in the fixed mold mounting plate 11. The adjustment of the tool height can be carried in a manner known per se, for example via a thread situated on the tie bar 18 in the area of the end plate 9, and a pertaining adjustment nut. The thread and the adjustment nut, like much other necessary apparatus of the injection molding machine, are not part of the invention, and have been omitted from the Figures for the sake of simplicity.

The closing unit 1 includes a drive mechanism, generally designated by reference numeral 2 and configured as piston and cylinder unit 3, for operating a toggle mechanism, generally designated by reference numeral 4. The drive mechanism 2 has a cylinder tube 19 in which a piston 25 reciprocates, with the piston 25 connected to a piston rod 14 extending outwards.

The toggle mechanism 4 includes a pair of linkages 5, 6, which are connected to one another at a knuckle point 13. The linkage 5 has a generally triangular configuration and is connected to a fixed end plate 9, shown only schematically here, at a knuckle point 7, and connected to the cylinder tube 19 of the drive mechanism 2 at a knuckle point 12. The linkage 6 is formed as a lever and connected to the moveable mold mounting plate 10 at a knuckle point 8. The relationship between the knuckle points is such that the knuckle point 12 (point of articulation of the linkage 5 upon the cylinder tube 19) is spaced at relatively great distance from the knuckle point 7 (point of articulation of the linkage 5 upon the end plate 9) and the knuckle point 13 (point of articulation of both linkage 5, 6). Suitably the sum of the distance of the knuckle point 12 to the knuckle points 7, 13 is greater than 1.2 times the distance between the knuckle points 7, 13.

The piston rod 14 of the drive mechanism 2 is connected at a point of articulation 17 to a second pair of linkages in the form of levers 15, 16, whereby lever 15 is connected to the end plate 9 at the knuckle point 7, and lever 16 is connected to the moveable mold mounting plate 10 at the knuckle point 8.

FIG. 1 shows the closing unit 1 in closed state, in which the piston rod 14 of the piston and cylinder unit 3 is fully extended and moved out of the cylinder tube 19. The knuckle point 12 of the linkage 5 upon the cylinder tube 19 is hereby shifted all the way to the left in FIG. 1, i.e. the triangular linkage 5 rotates about the knuckle point 7 such that the knuckle point 13 is in line with the connecting line of the knuckle points 7, 8. As a consequence, the toggle mechanism 4 is fully extended and the moveable mold mounting plate 10 is fully shifted in closing direction, so that the closing unit 1 is in closed position. The point of articulation 17 of the levers 15, 16 upon the piston rod 14 are hereby shifted all the way to the right, as shown in FIG. 1.

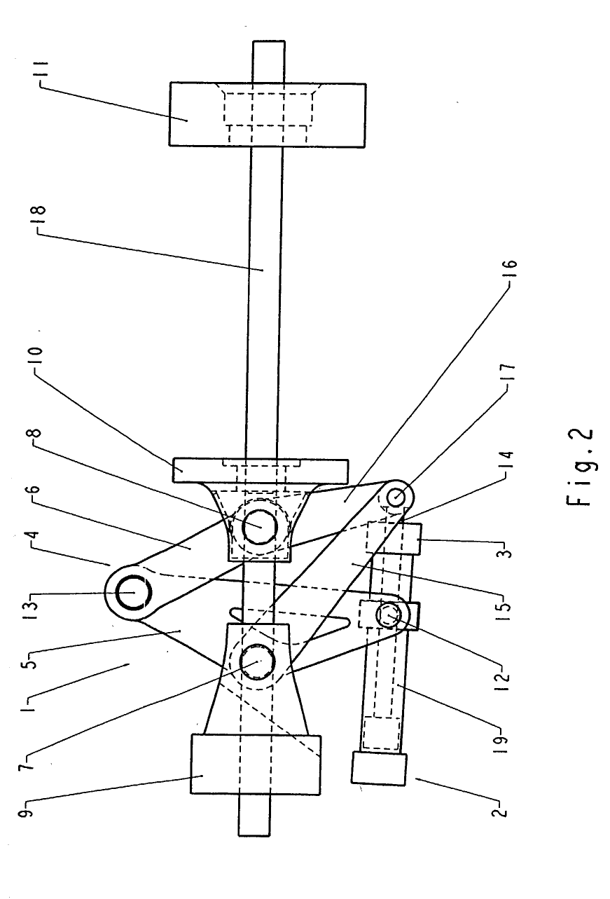

When the closing unit 1 is opened, the piston rod 14 of the drive mechanism 2 retracts into the cylinder tube 19. As a result, the knuckle point 12 of the linkage 5 upon the piston rod 14 is shifted to the right, as shown in FIG. 2. The triangular linkage 5 rotates hereby about the knuckle point 7, thereby pushing the knuckle point 13 upwards, so that the toggle mechanism 4 becomes increasingly angled or compressed. The moveable mold mounting plate 10 travels hereby to the left, i.e. in opening direction, so that the closing unit 1 opens. This opening position is shown in FIG. 2. During opening of the closing unit 1, the cylinder tube 19 executes a slight pitching motion, resulting in a minor downwards shift of its center of gravity.

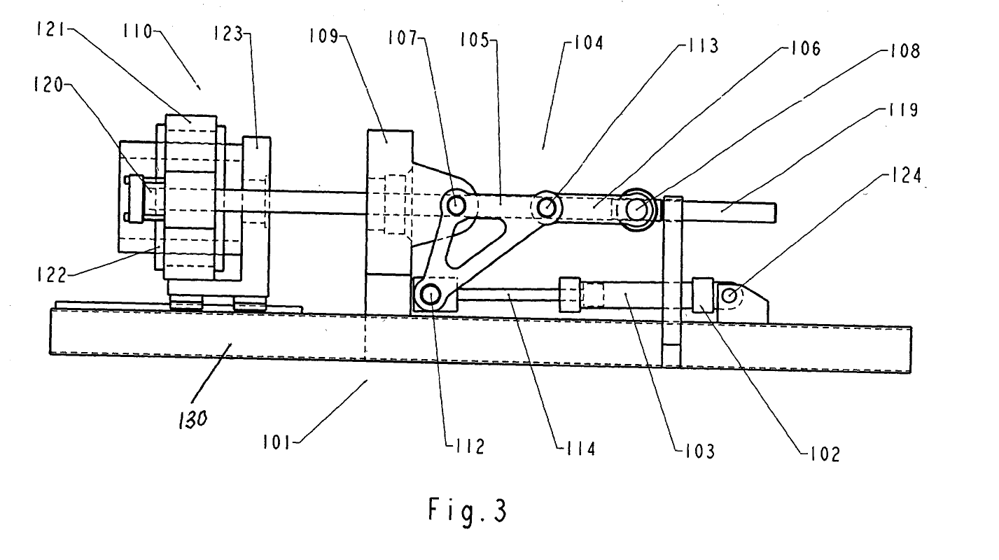

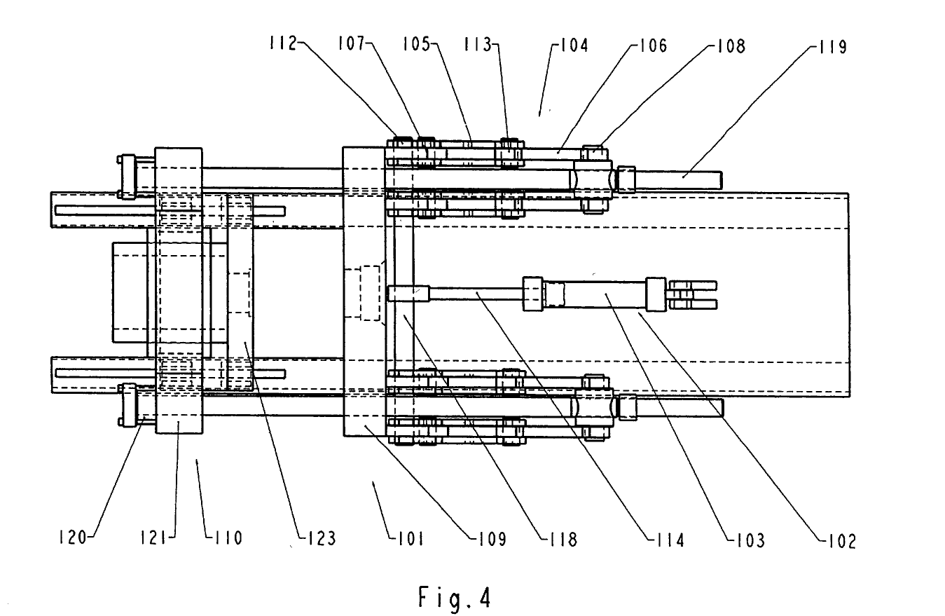

Turning now to FIGS. 3 and 4, there is shown a second embodiment of a closing unit according to the present invention, generally designated by reference numeral 101, for use in an injection molding machine. In the following description, parts corresponding with those in FIG. 1 will be identified by corresponding reference numerals, each increased by “100”. The injection molding machine is of two-platen design and includes a moveable mold mounting plate 110 and a fixed mold mounting plate 109. The closing unit 101 includes a drive unit 102 in the form of a piston and cylinder unit 103 which is securely fixed at point of articulation 124 to machine bed 130 of the injection molding machine and has a piston rod 114 for operating via a cross head 118 two toggle mechanisms 104 arranged in symmetry to the longitudinal axis of the injection molding machine, as shown in FIG. 4. Each of the toggle mechanisms 104 includes two linkages 105, 106, which are connected to one another at a knuckle point 113. The linkage 105 has a generally triangular configuration and is connected to the fixed mold mounting plate 109 at a knuckle point 107, whereas the linkage 106 is formed as a lever and connected to a tie bar 119 at a knuckle point 108. The tie bar 119 plunges through the fixed mold mounting plate 109 and is connected via a nut 120 with a base plate 121 of the moveable mold mounting plate 110. Connected to the base plate 121 via an adjustment nut 122 is a front plate 123 for receiving a tool, not shown. The provision of the adjustment nut 122 allows conforming the closing unit 101 to the size of the tool. The piston and cylinder unit 103 thus moves the moveable mold mounting plate 110 indirectly. Each side of the crosshead 118 is hereby connected via an additional knuckle point 112 with the triangular linkage 105 of the toggle mechanisms 104, whereby the knuckle point 112 is spaced at relatively great distance from the knuckle point 107 (point of articulation of the linkage 5 upon the fixed mold mounting plate 109) and the knuckle point 113 (point of articulation of the linkages 105, 106). Suitably the sum of the distances of the knuckle point 112 from the knuckle points 107, 113 is greater than 1.2 times a distance between the knuckle points 107, 113.

FIGS. 3 and 4 show the closing unit 101 in closed position, whereby the piston rod 114 of the drive mechanism 102 is fully extended. The knuckle point 112 of the linkage 105 has shifted all the way to the left, i.e. the triangular linkage 105 rotates about its knuckle point 107 such that the knuckle point 113 is in line with the connecting line of the knuckle points 107, 108. As a result, the toggle mechanisms 104 are thus fully extended so that the moveable mold mounting plate 110 is moved fully in closing direction. The closing unit 101 is thus closed.

When the closing unit 101 is opened, the piston rod 114 of the piston and cylinder unit 103 is retracted. As a result, the knuckle point 112 of the linkage 105 upon the piston rod 114 is shifted to the right. The triangular linkage 105 rotates hereby about the knuckle point 107, thereby pushing the knuckle point 113 (point of articulation of both linkages 105, 106) upwards, so that the toggle mechanism 104 becomes increasingly angled or compressed. The knuckle point 108 (point of articulation of the lever 106 upon the tie bar 119) shifts to the left so that the tie bar 119, extending through the fixed mold mounting plate 109, travels hereby to the left, i.e. in opening direction, so that the closing unit 101 opens. During opening of the closing unit 101, the piston and cylinder 103 executes a slight pitching motion.

While the invention has been illustrated and described as embodied in a closing unit for an injection molding machine or press, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A mold closing unit for an injection molding machine or press; comprising:
a drive mechanism; and
a toggle mechanism having a first pair of linkages connected to one another at a first knuckle point, one linkage connected to a stationary component at a second knuckle point and the other linkage connected to a movable mold mounting plate at a third knuckle point, at least one of the linkages operatively connected to the drive mechanism at a fourth knuckle point, wherein the fourth knuckle point is spaced from the first knuckle point by a first distance, and spaced from the second knuckle point by a second distance, wherein a sum of the first and second distances is greater than 1.2 times a distance between the first and second knuckle points.

2. The closing unit of claim 1, and further comprising a second pair of linkages connected to the drive mechanism at a fifth knuckle point.

3. The closing unit of claim 1, wherein the drive mechanism is connected, directly or indirectly, to a machine bed of the injection molding machine or press at a point of articulation.

4. The closing unit of claim 1, wherein the stationary component is an end plate, with the toggle mechanism positioned to operate between the end plate and the moveable mold mounting plate.

5. The closing unit of claim 1, wherein the stationary component is fixed mold mounting plate, with the toggle mechanism positioned to operate between the fixed mold mounting plate and the moveable mold mounting plate.

6. The closing unit of claim 1, wherein the drive mechanism is arranged in a direction substantially along a closing operation.

7. The closing unit of claim 1, and further comprising a second said toggle mechanism, wherein the two toggle mechanisms are arranged in symmetric relationship to a longitudinal center axis of the injection molding machine or press.

8. The closing unit of claim 7, wherein the two toggle mechanisms are movable by the drive mechanism via a crosshead.

9. The closing unit of claim 1, wherein the drive mechanism is one of a spindle drive with a quill motor, and a linear drive.

10. The closing unit of claim 1, wherein the drive mechanism is a double-acting hydraulic cylinder.

11. The closing unit of claim 1, wherein the at least one of the linkages has a triangular configuration.
